(19) United States
(12) Patent Application Publication
(10) Pub. No.: US 2009/0118908 A1
(43) Pub. Date: May 7, 2009

(54) Vehicle Safety Zone System

(75) Inventors: Timothy C. Fuller, Beavercreek, OR (US); Paul A. Comfort, Portland, OR (US); Melvin M. Priday, Clackamas, OR (US)

Correspondence Address: STOEL RIVES LLP, 900 SW FIFTH AVENUE, SUITE 2600, PORTLAND, OR, 97204-1268, US

(73) Assignee: FULLER BROS., INC., Clackamas, OR (US)

(21) Appl. No.: 11/630,296

(22) PCT Filed: Jun. 21, 2004
(86) PCT No.: PCT/US04/19886

§ 371 Date: Mar. 12, 2007

(51) Int. Cl. G06F 17/00

(52) U.S. Cl. 701/45; 701/2

(57) ABSTRACT

A remote tire measurement system (82) periodically transmits interrogation pulses from controller (88) with transceiver (84) that are detected by telemeters (70). The telemeters will not respond unless the remote measurement system is within communication range of the telemeter, thereby forming a safety perimeter around a vehicle (102). The remote system receives the tire inflation gas parameter data and/or a coded data response and annunciates a safety zone warning.

### TECHNICAL FIELD

This invention relates to tire inflation gas parameter telemetry systems and more particularly to a vehicle safety zone perimeter established by such systems, especially those employed by off-the-road mining trucks, which have limited driver-visibility patterns.

### BACKGROUND OF THE INVENTION

FIG. 1 shows a large mining ore truck 10, which is typical of many large vehicles that have experienced an ongoing problem with collisions resulting from limited maneuverability and driver vision. FIG. 2 shows typical blind areas 12 and mirror sight paths 14 experienced by a driver in a cab 16 of mining ore truck 10. These visibility limitations have resulted in a high incidence of accidents in which mining ore trucks collide with other vehicles, items of plant, and occasionally people. During the 1990s, hundreds of collisions were reported involving large mining ore trucks in open pit coal mines. Of these, a large proportion resulted from poor driver visibility. Remarkably there were few fatalities but property damage and lost productivity were significant.

Protections against such collisions typically included procedural or “soft” barriers, such as no-go zones for light vehicles, standard parking and start-up procedures, and audible reversing alarms. However, these procedural controls and reversing alarms have not eliminated heavy vehicle collisions. Moreover, the noise produced by reversing alarms has come under review in mines operating close to residential areas.

Even assuming that a vehicle driver could be provided with unlimited 360 degree vision around mining ore truck 10, this would still be inadequate because of the vehicle size. The driver would only be able to look in a limited number of directions at once, creating a potential for safe driving distractions.

Prior workers have addressed this problem by providing enhanced driver vision systems supplemented by automatic object detection systems that sense in all high risk directions, identify potential problems, and alert the driver to areas of potential collisions. In addition, the prior systems provide warning information to both the vehicle driver and the objects or personnel at risk.

An example of such a prior system is the Collision Avoidance System developed by Advanced Mining Technologies of Chittaway Bay, Australia. The system improves heavy vehicle safety and reduces the need for audible reversing alarms by improving driver vision with video displays and automatically detecting and classifying at-risk objects with radio frequency transponders. While effective, the system is costly and complex, and does not account for other safety hazards and down-time costs encountered in heavy vehicle operations.

Referring again to FIG. 1, for example, giant off-the-road tires 18, particularly those employed by earth moving and mining ore trucks 10, are subjected to very heavy loads that make them susceptible to premature failure unless proper inflation gas pressures are maintained. Such tires are even subject to dangerous explosive failure if the inflation gas is over-pressured of includes an oxygen concentration exceeding certain limits. Indeed, workers have been killed by exploding vehicle tires. For this reason, many mining ore truck operators are now using dry nitrogen as an inflation gas. Even so, trapped fluids and gases, air leaks, hydrocarbon out-gassing, and osmosis can cause a dangerous oxygen buildup inside the tires.

Regarding operating costs, a typical mining ore truck can weigh up to 550 tons when loaded and carries its heavy loads on only six of tires 18. A typical tire 18 is inflated to an operating pressure ranging from about 85 to 185 pounds per square inch of gauge pressure (“psig”) and, when operating, may have an operating temperature ranging from about 100 to 255 degrees Fahrenheit (“° F.”). If the tire pressure is too high, a failure mode (explosion) may occur. However, if the tire pressure is too low, the excess heat generated may cause separation of some of the 18 to 22 tire layers after as few as 300 hours of operation, whereas such tires normally have at least a 1,000 hour operating life. Giant off-the-road tires cost about $25,000 to $30,000 each, and vehicle downtime costs at least about $500 per hour. Clearly, maintaining proper tire operating pressure is an economic and safety imperative.

### SUMMARY OF THE INVENTION

An object of this invention is, therefore, to provide an apparatus and a method for measuring tire inflation gas parameters without requiring a tire cool down period.

Another object of this invention is to provide an apparatus and a method for combining a safety zone monitoring capability and the tire inflation gas parameter measuring system.

A further object of this invention is to provide a safety zone and tire parameter measuring apparatus and a method that is readily transferable among tires and vehicles.

A tire inflation gas parameter monitoring system of this invention is installed inside each tire being monitored and includes a telemetry system that further forms the basis of a safety zone monitoring system of this invention. A vehicle and personnel proximity detection capability is added to the telemetry system to detect close proximity of vehicles, property, and/or personnel to warn personnel of the proximity so that appropriate actions can be taken to alleviate personal injury, property damage, or vehicle damage.

The detection capability is added by modifying remote measurement systems to periodically transmit broadcast-coded interrogation pulses that can be detected by telemeters installed within the tires being monitored. The telemeters will not respond until the remote measurement systems are within communication range of the telemeters. The communication forms a safety zone perimeter around the vehicle.

When the broadcast-coded interrogation pulses are detected by the telemeters, they respond with tire inflation gas parameter data and/or a broadcast-coded data response. The remotes receive the tire inflation gas parameter data and/or a broadcast-coded data response and annunciate a safety zone warning.

A remote measurement system in the vehicle is modified to detect the broadcast-coded interrogation pulses from any of the remotes or the telemeters and annunciate a safety zone warning to the vehicle driver.

Additional objects and advantages of this invention will be apparent from the following detailed description of a preferred embodiment thereof that proceed with reference to the accompanying drawings.

### BRIEF DESCRIPTION OF THE DRAWINGS

FIG. 1 is an isometric pictorial view of an exemplary prior art mining ore truck suitable for employing this invention.

FIG. 2 is a top view of a typical mining ore truck driver visibility and blind spot pattern.

FIG. 3 is an electrical block diagram of a tire inflation gas parameter measuring system of this invention.

FIG. 4 is a functional block diagram of a vehicle safety zone system of this invention employing elements of the tire inflation gas parameter measuring system of FIG. 3.

### DETAILED DESCRIPTION OF PREFERRED EMBODIMENTS

This application is related to co-pending application Ser. No. 10/001,424, filed Nov. 13, 2001; U.S. Pat. No. 6,486,771 for TIRE INFLATION GAS TEMPERATURE, PRESSURE, AND OXYGEN MONITORING SYSTEM; and U.S. Pat. Nos. 6,292,095 and 6,025,777, for OFF-THE-ROAD TIRE TEMPERATURE AND PRESSURE MONITORING SYSTEM; all of which are assigned to the assignee of this application and are incorporated herein by reference.

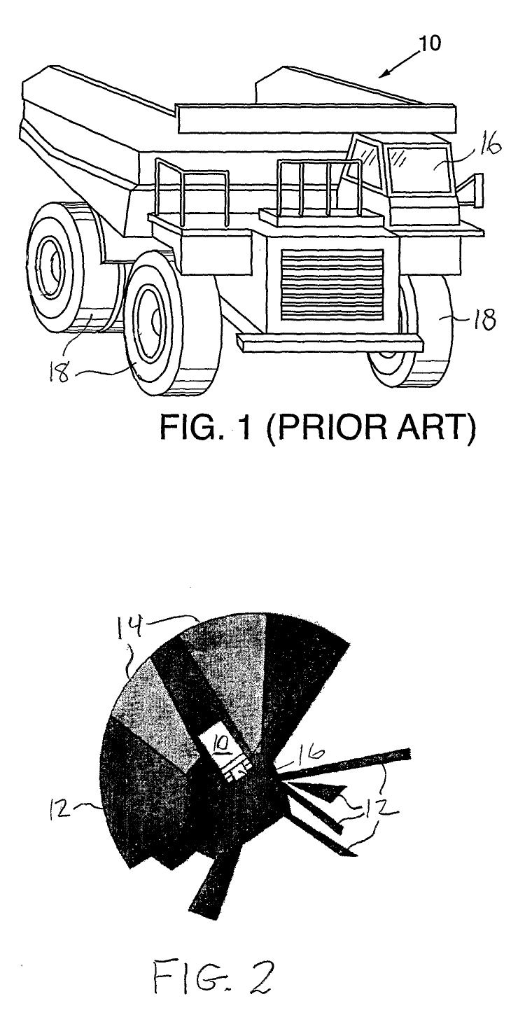

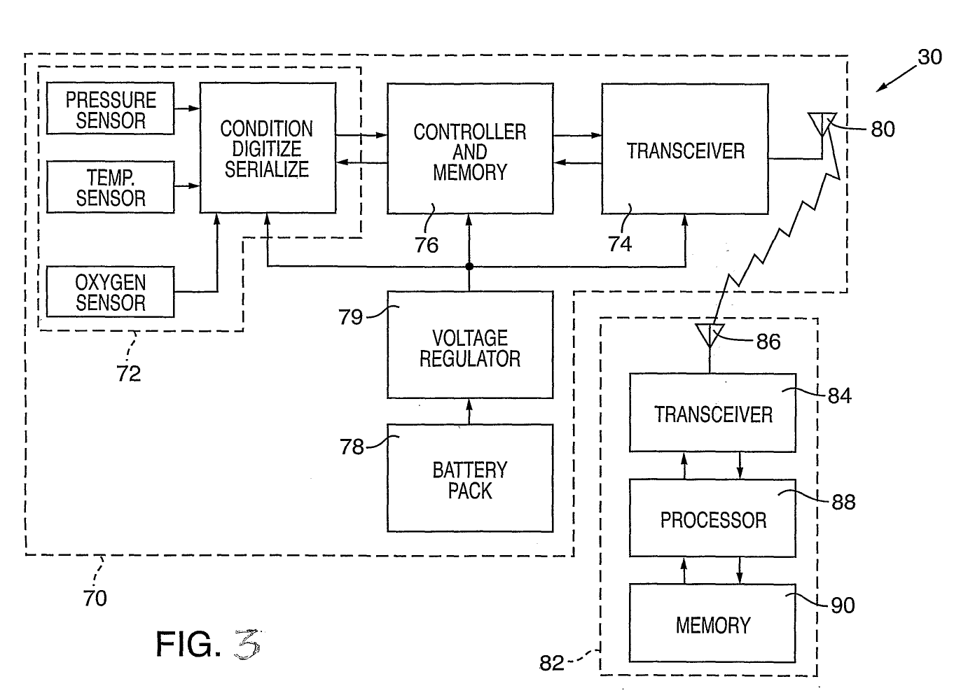

FIG. 3 shows a tire inflation gas telemetry system 30 that is suitable for implementing a safety zone of this invention. A telemeter 70 includes tire inflation gas parameter sensors, such as a pressure, temperature, and oxygen sensors 72, a data transceiver 74, a controller 76, a battery pack 78, voltage regulator 79 and a flexible quarter-wavelength monopole antenna 80. Telemeter 70 is designed for installation inside of at least one, and preferably each tire 18 of a vehicle, such as mining ore truck 10 (FIG. 1). Field testing has revealed that when telemeter 70 is inside a tire 18, antenna 80 should be at least about 25.4 centimeters (10 inches) off the tire floor to increase transmission efficiency through the tire side wall.

Sensed tire inflation gas parameter data are transmitted by transceiver 74 to a remote measurement system 82 while the vehicle is in operation. Tire life can be significantly improved by remotely measuring tire the inflation gas parameters at the end of each ore-transporting run, computing in remote measurement system 82 any tire pressure and gas changes required, and adjusting same accordingly before the next run. The sensing and computing is preferably carried out as described in the above-listed U.S. Pat. Nos. 6,025,777, 6,292,095, and 6,486,771.

Controller 76 preferably includes a model MC68HC11 CMOS microprocessor that is manufactured by Motorola, Inc. located in Phoenix, Ariz. The microprocessor includes on-chip random access memory and electrically erasable programmable read-only memory to support program memory and data transmission functions. Data transceiver 74 is a conventional 900 MHz data transceiver, such as ones employed in wireless telephones. Because it employs on-demand burst data transmission, telemeter 70 has a very low standby power drain, resulting in a typical battery lifetime of about one year when lithium batteries are employed.

Remote measurement system 82 includes a data transceiver 84 and an antenna 86 that intercommunicate with data transceiver 74 and antenna 80. Data transceiver 84 intercommunicates with a processor 88, such as a conventional laptop personal computer that includes a memory 90. Because remote measurement system 82 is preferably hand-held, processor 88 and memory 90 are preferably a model PC9000-A/D manufactured by DAP Technology Corporation of Tampa, Fla. Of course, a wide variety of PC types are usable including tower, rack, laptop, desktop, and personal data assistant (“PDA”) versions.

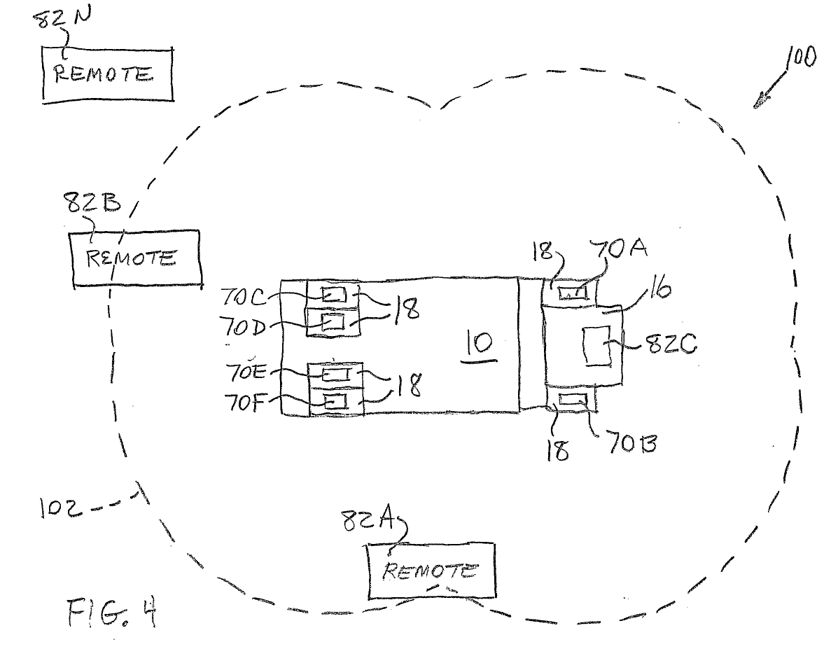

Referring also to FIG. 4, a vehicle, such as mining ore truck 10, preferably has a tire pressure and temperature telemeter 70 installed within each of tires 18. In FIG. 4, telemeters 70 are shown as telemeters 70A, 70B, 70C, 70D, 70E, and 70F (collectively “telemeters 70”). Each of telemeters 70 are actuated by an respond with a unique identification code. When mining ore truck 10 approaches within about 61 meters (200 feet) of a remote measurement system 82A, an operator commands processor 88 to interrogate each of telemeters 70 with its identification code regarding the current inflation gas parameters inside each of tires 18. Processor 88 conveys the interrogation command to data transceiver 84 that transmits in sequence an interrogation burst to each of data transceivers 74, which each in turn exit standby mode, retrieve from the memory of associated controller 76 the inflation gas parameter data, and transmit the retrieved data to remote measurement system 82. The interrogation process may also be carried out by any of other remote measurement systems, such as 82B, 82N, or by a driver in cab 16 of truck 10 employing remote measurement system 82C.

Processor 88 stores in memory 90 the current inflation gas parameter data associated with each of tires 18 and follows the process or processes described in the above-listed U.S. Pat. Nos. 6,025,777, 6,292,095, and 6,486,771.

Telemetry system 30 further forms the basis of a safety zone monitoring system 100 of this invention. A vehicle and personnel proximity detection capability is added to telemetry system 30 to detect close proximity of vehicles, property, and/or personnel to warn personnel of the proximity so that appropriate actions can be taken to alleviate personal injury, property damage, or vehicle damage.

The detection capability is added by modifying, preferably by programming, remote measurement systems 82A, 82B, and 82N to periodically transmit broadcast-coded interrogation pulses without operator intervention. The broadcast-coded interrogation pulses can be detected by any of telemeters 70. However, telemeters 70 will not respond until at least one of remotes 82A, 82B, and 82N are within communication range of at least one of telemeters 70. The typical communication range is about 61 meters (200 feet) and forms a safety zone perimeter 102 around truck 10.

In the example shown in FIG. 4, remotes 82A and 82B are inside safety zone perimeter 102, whereas remote 82N is not. In this scenario, the broadcast-coded interrogation pulses from either of remotes 82A and 82B would be detected by telemeters 70, which respond with tire inflation gas parameter data and/or a broadcast-coded data response. Remotes 82A and 82B receive the tire inflation gas parameter data and/or a broadcast-coded data response and annunciate a safety zone warning, which is preferably an audio sound and may include a visual indication, such as a flashing screen indication. In this way, personnel in proximity to any of remotes 82A or 82B are warned of a potential collision.

Remote measurement system 82C in cab 16 of truck 10 does not require the same modifications as the other remotes because it is always inside safety zone perimeter 102. In fact, periodic transmission of interrogation pulses would cause unneeded responses from telemeters 70 that could prematurely deplete their batteries. Therefore, remote 82C is modified, preferably by programming, to detect the broadcast-coded interrogation pulses from any of remotes 82A, 82B, and 82N, and/or broadcast-coded response codes from and of telemeters 70 and annunciate a safety zone warning, which is preferably an audio sound and may include a visual indication, such as a flashing screen indication. In this way, the driver of truck 10 is warned that of remotes 82A or 82B are within safety zone perimeter 102. This also provides a warning whenever two or more of trucks 10 are within a safety zone perimeter of one another.

A typical collision avoidance scenario employing safety zone monitoring system 100 is in an open-cut mine site including operations between moving vehicles on haul roads, loading and dump sites, around high wall and various bench levels and around other mine site obstacles such as buildings, plant and equipment etc. Safety zone monitoring system 100 is preferably configured to detect at risk heavy vehicles, light vehicles, stationary objects, personnel, and test stations.

Skilled workers will recognize that portions of this invention may be implemented differently from the implementations described above for preferred embodiments. For example, this invention may be implemented on vehicles having fewer or more than six tires, may employ a telemeter in a few as one tire, may employ a wide variety of communications protocols, and is not limited to the 900 MHz frequency band. Embodiments employing radio-frequency networked computers, such as Wi-Fi-enabled laptop and/or PDA computers are envisioned. This invention is not limited to use in the mining industry. Other application areas may include quarrying, construction; refuse, transportation, fire fighting, emergency services, agricultural, recreational, aircraft, and any other poor visibility applications in which potentially hazardous conditions exist.

It will be obvious to those having skill in the art that many changes may be made to the details of the above-described embodiments of this invention without departing from the underlying principles thereof. Accordingly, it will be appreciated that this invention is also applicable to apparatus mounting applications other than those found in the inflation gas monitoring of heavy truck tires. The scope of the present invention should, therefore, be determined only by the following claims.

We claim:

1. An apparatus for establishing a safety zone perimeter around a vehicle having multiple tires and a cab, comprising:
a tire inflation gas parameter telemeter transmitting data associated at least one of the tires; and
at least one remote transceiver receiving the data and annunciating a warning indicative of the remote transceiver being within the safety zone perimeter.

2. The apparatus of claim 1, in which the remote transceiver further employs a processor for extracting tire inflation gas parameter measurements from the data.

3. The apparatus of claim 1, in which the telemeter transmits the data in response to an interrogation signal from the remote transceiver.

4. The apparatus of claim 3, in which the interrogation signal is initiated by an operator of the remote transceiver.

5. The apparatus of claim 3, in which the interrogation signal is periodically initiated by the remote transceiver.

6. The apparatus of claim 3, further including a vehicle transceiver associated with the vehicle, the vehicle transceiver receiving at least one of the interrogation signal and the data and annunciating in the cab a warning indicative of the remote transceiver being within the safety zone perimeter.

7. The apparatus of claim 1, in which the safety zone perimeter extends from the telemeter out to at least about 61 meters (200 feet).

8. The apparatus of claim 1, in which the telemeter transmits tire inflation gas parameter data in response to receiving from the remote transceiver an interrogation signal including a unique tire identification code.

9. The apparatus of claim 1, in which the telemeter transmits the data in response to receiving from the remote transceiver an interrogation signal including a broadcast code.

10. The apparatus of claim 1, in which the vehicle includes an automobile, a light truck, a heavy truck, a mining ore truck, an aircraft, a construction vehicle; an agricultural vehicle, or a recreational vehicle.

11. A method for establishing a safety zone perimeter around a vehicle having multiple tires and a cab, comprising:
inserting a gas parameter telemeter inside at least one of the tires;
transmitting data associated at least one of the tires; and
receiving the data at a remote location within the safety zone perimeter; and
annunciating a warning indicative of receiving the data within the safety zone perimeter.

12. The method of claim 11, further including extracting tire inflation gas parameter measurements from the data.

13. The method of claim 11, in which the transmitting occurs in response to receiving an interrogation signal from a transceiver in the remote location.

14. The method of claim 13, in which the interrogation signal is initiated by an operator of the transceiver.

15. The method of claim 13, in which the interrogation signal is periodically initiated by the transceiver.

16. The method of claim 13, further including associating a vehicle transceiver with the vehicle, the vehicle transceiver receiving at least one of the interrogation signal and the data and annunciating in the cab a warning indicative of the vehicle transceiver being within the safety zone perimeter.

17. The method of claim 11, in which the safety zone perimeter extends from the vehicle out to at least about 61 meters (200 feet).

18. The method of claim 11, in which the telemeter transmits data including tire inflation gas parameter data in response to receiving an interrogation signal including a unique tire identification code.

19. The method of claim 11, in which the telemeter transmits the data in response to receiving an interrogation signal including a broadcast code.

20. The method of claim 11, in which the vehicle includes an automobile, a light truck, a heavy truck, a mining ore truck, an aircraft, a construction vehicle; an agricultural vehicle, or a recreational vehicle.
